(19) United States
(12) Patent Application Publication
(10) Pub. No.: US 2014/0161708 A1
(43) Pub. Date: Jun. 12, 2014

(54) CARBON DIOXIDE PRODUCTION

(71) Applicant: Clive Roger Stamp, Suffolk (GB)

(72) Inventor: Clive Roger Stamp, Suffolk (GB)

(73) Assignee: Rockfuel Innovations Limited, Colchester, Essex (GB)

(21) Appl. No.: 14/233,801

(22) PCT Filed: Jul. 10, 2012
(86) PCT No.: PCT/GB2012/051622

§ 371 Date: Jan. 20, 2014

(30) Foreign Application Priority Data
Jul. 21, 2011 (GB) 11 12492.2
Mar. 29, 2012 (GB) 12 05567.9

(51) Int. Cl. C01B 31/20

(52) U.S. Cl. CPC C01B 31/20
USPC 423/438; 422/186.04

(57) ABSTRACT

Apparatus for the production of carbon dioxide from limestone includes a nuclear energy source (32) arranged to generate electricity and a rotary kiln (10). The rotary kiln (10) has an inlet (15) for the introduction of limestone and an outlet (19) for the release of carbon dioxide. An electrical resistance heating element (21) disposed within the kiln (10) is arranged to be supplied with electricity derived from the nuclear energy source (32) to raise the temperature of the element (21) for transfer of heat to the interior of the rotary kiln (10). Limestone in the rotary kiln (10) is thereby heated to a temperature sufficient for the release of carbon dioxide.

This invention relates to apparatus for the production of carbon dioxide from limestone and also to a method for producing carbon dioxide. The invention finds particular use in the production of carbon dioxide for the subsequent manufacture of a synthetic fuel.

Fossil fuels are non-renewable energy sources which are rapidly depleting. The combustion of fuel manufactured from crude oil creates large quantities of greenhouse gases. With increasing concerns of climate change due to greenhouse gases, there is a need to reduce the amount of air pollution caused by the combustion of fuels and by industrial manufacturing processes. Due to the limited number of oil reserves, it is necessary to transport large quantities of oil from the oil reserves to the consuming areas, often over great distances. The transportation of oil in this way inevitably causes more pollution, additional to that from the burning of the oil being transported.

In an attempt to reduce fossil fuel use and eliminate pollution caused by the burning of such fuels, there is an increasing need for environmentally sustainable energy sources. Processes for producing synthetic fuels using carbon dioxide and hydrogen are well established. However, obtaining carbon dioxide directly from the atmosphere is not only expensive but is also problematic in that the extraction process can create yet even more pollution.

It is a principal aim of the present invention to address the environmental damage caused by the combustion of fossil fuels and to provide apparatus and a method for producing carbon dioxide from limestone which can be used for the subsequent manufacture of a synthetic and environmentally sustainable fuel. The invention aims to reduce energy consumption and the production of harmful emissions by the manufacture of synthetic fuels, so as to have a smaller impact on the environment and climate change.

According to a first aspect of this invention, there is provided apparatus for the production of carbon dioxide from limestone, comprising a nuclear energy source arranged to generate electricity, a rotary kiln having an inlet for the introduction of limestone and an outlet for the release of carbon dioxide, and an electrical resistance heating element disposed within the kiln for heating limestone contained therein, the heating element being arranged to be supplied with electricity derived from the nuclear energy source, whereby the temperature of the heating element is raised to transfer heat to limestone contained within the kiln to an extent sufficient to release carbon dioxide from the limestone.

According to a second but closely related aspect of this invention, there is provided a method for producing carbon dioxide from limestone comprising the steps of:

a) heating an electrical resistance heating element disposed within a rotary kiln, to raise the temperature within the kiln, using electricity derived from a nuclear energy source;

b) introducing limestone into the rotary kiln through an inlet thereto, to be heated by the heating element;

c) operating the rotary kiln to rotate about a longitudinal axis; and

d) collecting carbon dioxide released from the limestone, through an outlet from the rotary kiln, whereby the heat transferred from the heating element to the limestone and the rotation of the rotary kiln causes calcination of the limestone to produce carbon dioxide.

Calcination of limestone by heating releases carbon dioxide and produces quicklime. The heating of limestone in conventional rotary kilns is carried out by burning fossil fuels, which is environmentally unsustainable. The apparatus of this invention addresses this problem by using the heat generated by nuclear energy to heat the limestone in a rotary kiln. The heat required by the rotary kiln in order most efficiently to release carbon dioxide from limestone is in the region of 900° C. to 950° C., though of course, carbon dioxide can be released at lower temperatures.

The nuclear energy source is preferably a nuclear reactor such as a water cooled reactor, a liquid metal cooled reactor a gas cooled reactor (GCR), a molten salt reactor or a generation IV reactor. Other types of nuclear reactor can be used including, but not limited, to a boiling water reactor (BWR), a pressurised water reactor (PWR), a breeder reactor, a high temperature gas cooled reactor, a pebble bed reactor (PBR) or vodo-vodyanoi energetichesky reactor PWR (PWR-VVER), a canada deuterium uranium reactor (CANDU reactor), a D2O PWR, an advanced gas-cooled reactor (AGR), a high temperature helium cooled reactor, a light-water-cooled graphite-moderated reactor (LWGR), a thorium-fuel reactor and/or a thorium dual-fuel reactor.

The electrical resistance heating element disposed within the kiln is electrically powered and the nuclear energy source generates electricity which may be supplied through a suitable control unit to the heating element, to raise the temperature within the kiln. Advantageously, the nuclear energy source may generate electricity directly utilising the thermoelectric effect and so typically may comprise thermocouples, thermopiles, thermionic converters or similar apparatus. In the alternative, the nuclear energy source is arranged to generate electricity indirectly, by heating water to produce steam and using the steam to power a turbine driving an electricity generator.

By employing any of these arrangements described above, or perhaps in other ways, the heating element employed in this invention may be supplied with energy from a nuclear energy source, to cause the temperature within the rotary kiln to be raised sufficiently for the calcination of limestone and so the production of carbon dioxide.

Preferably, the rotary kiln comprises an outer generally cylindrical vessel for containing the limestone, that vessel being mounted for rotation about a generally horizontal axis, or an axis inclined at a small angle to the horizontal. The heating element may be arranged within an inner chamber disposed substantially co-axially within the vessel. In use, the outer rotary vessel rotates about the stationary inner chamber, mixing and tumbling the limestone over the hot inner chamber to cause calcination of that limestone.

The production of carbon dioxide from limestone is preferably carried out as a batch-type process rather than a continuous process. This allows calcinated limestone (in the form of quicklime) to be discharged from the kiln and a fresh charge of limestone to be added to the kiln, while the rotary vessel is held stationary. Suitable valve arrangements should be provided for openings into the rotary kiln, to allow the removal of quicklime and the introduction of limestone.

The waste quicklime released from the kiln will absorb carbon dioxide from the atmosphere. The quicklime could be used in vehicle exhaust filters or along motorways or other areas of high carbon dioxide pollution. Additionally or alternatively, the quicklime could be made into mortar-like slabs which could be utilised in sea defences, new quays and the like. Quicklime is particularly good at absorbing carbon dioxide when placed in water and this could be especially beneficial in coastal projects. Thus the carbon dioxide production method of this invention could become carbon neutral. In this way, the present invention could be used as a carbon dioxide sequestration plant, whereby the carbon dioxide, generated as a result of heating limestone in the kiln, is stored and the resultant quicklime used to absorb carbon dioxide from the atmosphere, as discussed above. The absorption of carbon dioxide by the quicklime will result in limestone which can be recycled back into the kiln and the resultant carbon dioxide sequestrated. Such a cycle would cumulatively remove CO2 from the atmosphere.

The quicklime produced by the calcination of limestone in the apparatus will be relatively hot when discharged. Rather than losing that heat to the environment, it is preferred that heat recovery means is provided to extract the heat from the hot quicklime discharged from the rotary kiln. The heat recovery means may comprise means to cause air to flow over the hot quicklime thereby to transfer heat from the quicklime to the air. Alternatively a heat exchanger may be arranged to extract the heat from the quicklime by blowing air over the quicklime and passing that air through a fluid-to-air heat exchanger, so producing hot water for other uses.

Preferably the apparatus includes a pre-heater for heating the limestone prior to introduction of the limestone to the rotary kiln to prevent a sudden temperature drop within the kiln. Advantageously, the pre-heater may be connected to the heat recovery means to be supplied with the hot air or water resulting from the cooling of the quicklime. In this way, the heat removed from the quicklime by the heat recovery means can be recycled back into the apparatus.

A hydrogen plant may be provided with heat and/or steam from the nuclear energy source, so that the overall apparatus produces both carbon dioxide and hydrogen. Then, the overall system can be used as a part of a synthetic fuel production plant, as the system produces both of the necessary components: carbon dioxide and hydrogen. These gases can be processed to produce a synthetic fuel using any of the known methods, such as the Sabatier reaction. The hydrogen plant may be a solid oxide electrolysis cell (SOEC) plant.

By adding a hydrogen plant and a synthetic fuel production plant to the apparatus of this invention, the method of this invention may be used to facilitate the production of synthesis gas for use as a fuel, such as methanol or butane. Butane may be used as a gasoline substitute without requiring any further processing. The high temperatures and pressures produced by the apparatus during the process may be used within the synthetic fuel plant to facilitate the conversion.

Alternatively, the carbon dioxide generated in the kiln may be processed using different methods which do not require the use of a hydrogen plant to produce a sustainable synthetic fuel.

By way of example only, one specific embodiment of apparatus of this invention will now be described in detail, reference being made to the accompanying drawings in which:

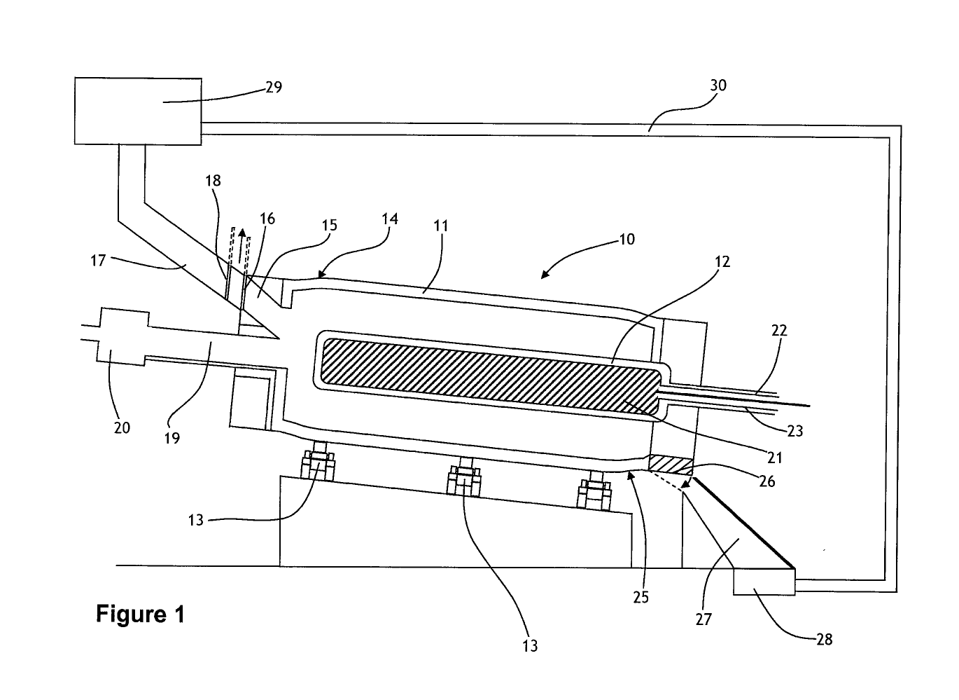

FIG. 1 is a diagrammatic section of a rotary kiln for the production of carbon dioxide from limestone in accordance with a method of this invention; and

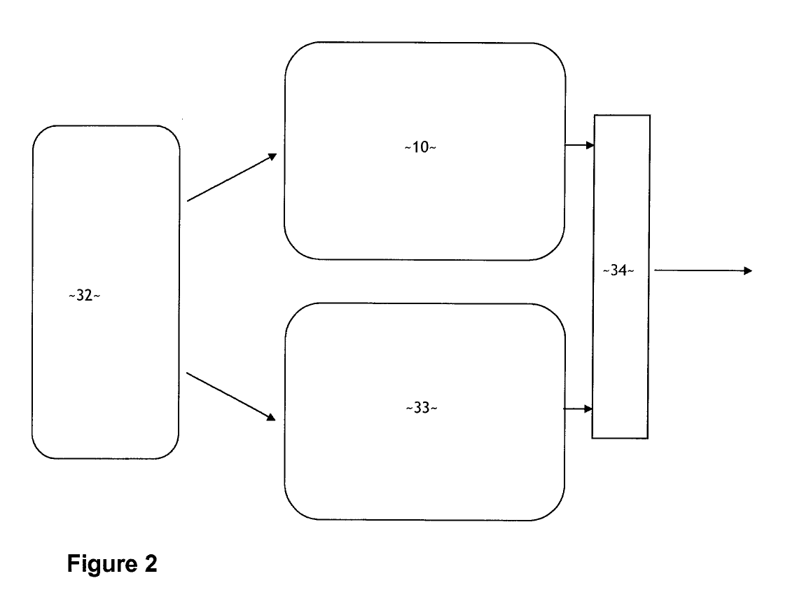

FIG. 2 is a diagrammatic view of the rotary kiln of this invention incorporated within a system for the production of a synthetic fuel.

Referring to FIG. 1, there is shown a rotary kiln 10 which comprises a generally cylindrical vessel 11 having an inner chamber 12 mounted coaxially therein. The vessel 11 is supported on three pairs of horizontally-spaced rollers 13 with the vessel axis inclined at a small angle to the horizontal. At least one roller 13 of each pair includes a motor (not shown) to effect rotation of the vessel. The kiln 10 has at its raised end 14 an inlet 15 for the introduction of limestone, that inlet being provided with a gate valve 16. A stationary inlet duct 17 also provided with a gate valve 18 is arranged so that on rotation of the vessel 11, the inlet 15 will come into register with the duct 17 when the inlet 15 is uppermost. When in register and both gate valves are opened, limestone may pass from the duct 17 to the inlet 15 and so into the vessel.

At the raised end 14 of the kiln, there is provided an outlet pipe 19 for carbon dioxide generated within the vessel. A gas-type rotary joint (not shown) is arranged between the vessel 11 and the pipe 19 and a valve (also not shown) is disposed within the pipe 19 to control the release of carbon dioxide. The pipe 19 feeds the carbon dioxide to a scrubber 20 to clean the carbon dioxide and discharge unwanted effluents to waste.

The inner chamber 12 of the kiln 10 is formed from stainless steel reinforced as necessary to withstand the tumbling of the limestone within the vessel 11. A resistive heating element 21 is disposed within the chamber 12, electricity supply cables 22 and 23 being connected to that element and being provided with electrical, thermal and mechanical insulation to allow the supply of electricity to the element to an external control unit (not shown). In turn, a nuclear power source such as a pressurised water reactor (PWR) or a breeder reactor is connected to the control unit whereby the heating element may be powered from the nuclear energy source, to raise the temperature within the kiln sufficiently to cause calcination of the limestone.

At the lower end 25 of the vessel 11, there is provided a door 26 which, when the inlet 15 is in register with the inlet duct 17, comes into register with an outlet duct 27, to enable the removal of quicklime produced by the calcination of limestone within the kiln. Beneath the door 26 in the duct 27 is a fluid-to-air heat exchanger 28 arranged to cool quicklime released from the kiln by blowing air over the hot quicklime and transferring the heat to liquid being passed through the heat exchanger.

A pre-heater 29 is connected to the inlet duct 17 and is arranged to heat limestone prior to introduction into the vessel 11. The pre-heater 29 is connected to the fluid-to-air heat exchanger 28 by pipes 30 so that the hot liquid from the heat exchanger 28 is used to pre-heat the limestone before introduction to the vessel 11.

Referring now to FIG. 2 there is shown diagrammatically apparatus for the manufacture of synthetic fuel and including the rotary kiln 10. A nuclear energy source 32 is arranged to generate electricity. A control system (not shown) controls the supply of electricity along cables 22, 23 to the heating element 21 within the inner chamber 12. Further, electricity is supplied to a hydrogen plant 33, for the production of hydrogen from water, by processes well known and understood in the art. In this case the hydrogen plant may be a SOEC plant 33. As with the electricity supplied to the heating element 21 of the kiln, a control system is provided for the hydrogen plant 33.

Carbon dioxide produced by the heating of the limestone within the rotary kiln is fed to a synthetic fuel gas plant 34 and hydrogen produced by the hydrogen plant 33 also is fed to that synthetic fuel gas plant. There, the carbon dioxide and hydrogen are combined by a known process using heat and pressure, in order to produce a synthetic fuel gas such as butane or propane. Such a process is well known and understood in the art and forms no part of this invention; as such, that process will not be discussed in further detail here.

The nuclear reactor may take any convenient form and may be arranged either to produce electricity directly by thermoelectric action (using thermocouples, thermopiles, thermionic converters or similar apparatus), or to heat fluid which may be used indirectly to produce electricity by powering a turbine which in turn drives a generator.

Whatever form of nuclear reactor employed, the temperature within the vessel 11 of the rotary kiln 10 should be raised to a temperature of the order of 900° C., at which temperature efficient conversion of the limestone to quicklime may be obtained, with the consequent production of carbon dioxide.

Limestone is introduced into the vessel 11 of the kiln through a pre-heater 29, in order to minimise the reduction of temperature within the vessel on introducing a fresh batch of limestone. The pre-heater 29 is supplied with heat produced from the cooling of quicklime previously released from the kiln 10, as has been described above. When the apparatus is started up after a period of non-use, the pre-heater 28 may be provided with heat from some other source, such as the nuclear energy source employed for heating the limestone within the kiln.

The rotary kiln 10 is turned to bring the inlet 15 uppermost and in register with the inlet duct 17 so that opening of the gate valves 16 and 18 allows the introduction of pre-heated limestone to the cylindrical vessel 11. The valves are closed and the vessel is rotated while the electricity produced by the nuclear energy source is supplied to the heating element 21 to heat the limestone as it tumbles around the chamber 12. The heating of the limestone causes the calcination thereof, so producing carbon dioxide, which is withdrawn from the vessel through outlet pipe 19. The scrubber 20 cleans the carbon dioxide stream. Quicklime is produced by the process and leaves the vessel 11 by opening the door 26 when the vessel is stopped with the inlet 15 uppermost. The quicklime is cooled by air passing thereover and through the heat exchanger 28, the resultant hot liquid being used to heat a fresh batch of limestone in the pre-heater 29 before introduction into the vessel 11.

1. Apparatus for the production of carbon dioxide from limestone, comprising a nuclear energy source arranged to generate electricity, a rotary kiln having an inlet for the introduction of limestone and an outlet for the release of carbon dioxide, and an electrical resistance heating element disposed within the kiln for heating limestone contained therein, the heating element being arranged to be supplied with electricity derived from the nuclear energy source, whereby the temperature of the heating element is raised to transfer heat to limestone contained within the kiln to an extent sufficient to release carbon dioxide from the limestone.

2. Apparatus as claimed in claim 1, wherein the nuclear energy source comprises at least one of a water cooled reactor, a liquid metal cooled reactor, a gas cooled reactor, a molten salt reactor and a generation IV reactor.

3. Apparatus as claimed in claim 1, wherein the nuclear energy source is arranged to generate electricity indirectly, by heating water to produce steam and using the steam to power a turbine driving an electricity generator.

4. Apparatus as claimed in claim 1 wherein the rotary kiln comprises an outer rotary vessel for the limestone and an inner stationary chamber, within which is provided the heating element for the transfer of heat to limestone in the outer rotary vessel.

5. Apparatus as claimed in claim 1, further comprising heat recovery means to recover heat from hot quicklime discharged from the rotary kiln.

6. Apparatus as claimed in claim 5, wherein said heat recovery means comprises means to cause air to flow over the hot quicklime thereby to transfer heat from the quicklime to said air.

7. Apparatus as claimed in claim 5, further comprising a pre-heater for heating the limestone prior to introduction of the limestone to the rotary kiln.

8. Apparatus as claimed in claim 7, wherein the pre-heater is connected to the heat recovery means for the supply of heat to the pre-heater.

9. A method for producing carbon dioxide from limestone comprising the steps of:
a) heating an electrical resistance heating element disposed within a rotary kiln, to raise the temperature within the kiln, using electricity derived from a nuclear energy source;
b) introducing limestone into the rotary kiln through an inlet thereto, to be heated by the heating element;
c) operating the rotary kiln to rotate about a longitudinal axis; and
d) collecting carbon dioxide released from the limestone, through an outlet from the rotary kiln, whereby the heat transferred from the heating element to the limestone and the rotation of the rotary kiln causes calcination of the limestone to produce carbon dioxide.

10. A method as claimed in claim 9, wherein at least one of a water cooled reactor, a liquid metal cooled reactor, a gas cooled reactor, a molten salt reactor and a generation IV reactor is used as the nuclear energy source.

11. A method as claimed in claim 9, wherein the nuclear energy source generates electricity, either directly or indirectly, and the electricity is supplied to an electrical heating element disposed within the rotary kiln, for heating the limestone.

12. A method as claimed in claim 9, wherein the source of nuclear energy produces steam which is fed to a hydrogen plant, for the production of hydrogen.

13. A method as claimed in claim 12, wherein the hydrogen plant comprises a solid oxide electrolysis cell plant.

14. A method as claimed in claim 9, wherein the limestone is heated by a pre-heater prior to introduction into the rotary kiln.

15. A method as claimed in claim 14, wherein quicklime produced by the calcination of the limestone is collected at a lower end of the rotary kiln and when the rotary kiln is stationary is released to heat recovery means for cooling.

16. A method as claimed in claim 15, wherein the heat recovery means causes air to flow over the hot quicklime thereby to transfer heat from the quicklime to said air.

17. A method as claimed in claim 15, wherein the pre-heater is supplied with heat from the heat recovery means.
